(19) United States
(12) Patent Application Publication
(10) Pub. No.: US 2003/0199219 A1
(43) Pub. Date: Oct. 23, 2003

(54) Patterned nonwoven fabric

(76) Inventor: Heather J. Hayes, Spartanburg, SC (US)

Correspondence Address: Terry T. Moyer, P.O. Box 1927, Spartanburg, SC, 29304, US

(21) Appl. No.: 10/126,096

(22) Filed: Apr. 19, 2002

(51) Int. Cl. B32B 1/00; D06N 7/04; D04H 1/00

(52) U.S. Cl. 442/401; 428/141; 442/340; 442/361

(57) ABSTRACT

The present disclosure relates to a patterned nonwoven fabric, wherein the pattern comprises an arrangement of discrete regions that project outwardly from a median plane of the nonwoven fabric. The outwardly projecting pattern may be created on one or both sides of the fabric, although the pattern may project further on one side than the other. In one embodiment, the patterned nonwoven fabric further includes a second arrangement of discrete regions, these regions projecting inwardly toward the median plane of the nonwoven fabric. Again, the pattern of inwardly and outwardly projecting regions may occur on one or both sides of the nonwoven fabric. The patterned nonwoven may be used in a variety of applications, such as drapery, upholstery, apparel, and office panels, for example.

### TECHNICAL FIELD

The present disclosure relates to a patterned nonwoven fabric, in which the pattern consists of a number of discrete regions projecting from the fabric surface. In one embodiment, the nonwoven fabric further includes a number of discrete regions projecting into the fabric surface, such as may be obtained by embossing or thermal bonding. The fabric may be patterned on one or both sides. The patterned fabric is useful in a variety of applications, such as apparel, automotive, upholstery, home and office furnishing, and drapery, for example.

### BACKGROUND

Nonwovens are known in the industry as an alternative to traditional woven or knit fabrics. To create a nonwoven fabric, a filament web must be created and then consolidated. Staple fibers are formed into a web through the carding process or through random orientation means in either wet or dry conditions. Alternatively, continuous filaments, which are formed by extrusion, may be used in the formation of the web. The web is then consolidated, and/or bonded, by means of needle-punching, thermal bonding, chemical bonding, or hydroentangling. A second consolidation treatment may also be employed.

A preferred substrate for the present disclosure is a nonwoven formed of continuous splittable filaments that are extruded as a web and then consolidated. The continuous multi-component filaments are obtained by means of a controlled spinning process. The continuous filaments have the following characteristics: (1) the continuous filaments are comprised of at least two elementary filaments and at least two different fiber types; (2) the continuous filaments are splittable along at least a plane of separation between elementary filaments of different fiber types; (3) the continuous filaments have a filament number (that is, titer or yarn count) of between 0.3 dTex and 10 dTex; and (4) the elementary filaments of the continuous filament have a filament number between 0.005 dTex and 2 dTex. Simply put, the nonwoven fabric can be described as a nonwoven fabric of continuous microfilaments. Such a fabric is described in U.S. Pat. Nos. 5,899,785 and 5,970,583, both to Groten et al., each of which is incorporated herein by reference.

The specific fabric described above is created by extruding a web of continuous filaments and then consolidating the web by hydroentanglement. Like other nonwoven fabrics, it may be further consolidated by thermal (or point) bonding or embossing. In the case of thermal bonding, the fibers are melted in a patternwise arrangement at the points where a heated roll contacts the fabric surface. Embossing has a similar effect on the fabric, in terms of creating a pattern of inwardly projecting regions, but may or may not result in melted fibers (that is, the fabric surface may merely be depressed or dimpled in the affected areas). Embossed or thermal bonded fabrics, as described, may also be used in the present product.

In fact, embossing and thermal bonding have been the primary methods used to create patterns on nonwoven fabrics. One problem with these patterning methods is the difficulty in obtaining intricate patterns. A second problem, especially in the case of thermal bonding, is that the melted fibers tend to adversely affect the hand or softness of the fabric. Furthermore, thermal bonding and embossing tend to flatten the fabric.

Another technique for patterning nonwoven fabrics is to subject the fabric to hydroentanglement through a patterned belt. Discrete streams of water are directed through the fabric, which is supported by a patterned belt. The fabric then assumes the pattern of the belt. Typically, such hydraulic processing results in a fabric with weak spots or holes. Although such holes may be part of the overall pattern applied to the fabric, such a result is not the object of the present disclosure.

Heretofore, few durable methods have been found that produce a pattern that projects outwardly from (or above) the fabric surface without significantly weakening the fabric. The present product includes such a patterned surface.

### SUMMARY

The present disclosure relates to a patterned nonwoven fabric, wherein the pattern comprises an arrangement of discrete regions that project outwardly from a median plane of the nonwoven fabric. The outwardly projecting pattern may be created on one or both sides of the fabric, although the pattern may project further on one side than the other. In one embodiment, the patterned nonwoven fabric further includes a second arrangement of discrete regions, these regions projecting inwardly toward the median plane of the nonwoven fabric. Again, the pattern of inwardly and outwardly projecting regions may occur on one or both sides of the nonwoven fabric. The patterned nonwoven may be used in a variety of applications, such as drapery, upholstery, and office panels, for example.

### BRIEF DESCRIPTION OF DRAWINGS

FIG. 1 is a cross-sectional schematic representation of an embossed or thermally bonded fabric;

FIG. 2 is a cross-sectional schematic representation of a patterned nonwoven fabric of the present product having projecting regions on the top and bottom surfaces thereof; and

FIG. 3 is a cross-sectional schematic representation of an embossed nonwoven fabric, which further includes projecting regions on the top and bottom surfaces thereof.

### DETAILED DESCRIPTION

Dimensional patterns may be effectively generated on a nonwoven fabric by using the techniques described in commonly assigned U.S. Pat. No. 5,235,733 to Willbanks et al., U.S. Pat. No. 4,828,174 to Love, and U.S. Pat. No. 5,033,143, also to Love, the disclosures of which are hereby incorporated by reference. These products are generated by a textile treatment process wherein one or more jets of high velocity fluid, for example, water, are directed onto a flat fabric surface that is supported by a solid, non-contoured backing member. The fluid jets, by interacting with the fabric and the backing member, create a pattern of remarkably uniform areas on the fabric surface. The pattern may be created by fluid jets that act in conjunction with a stencil or that are individually controlled in response to pattern information.

It is believed that the fluid jets, upon initial impact, pass through the fabric and collide with the surface of the backing member, where upon the fluid spreads over the surface of the backing member and tends to “float” the fabric on a thin film of fluid of substantially uniform thickness. Incoming jets can entrain, without significantly breaking or cutting, fabric yarn fibers as the jets pass through the fabric, resulting in patterned areas having a highly uniform observed pattern height.

As an additional benefit, it has been determined that a patterning action also occurs on the opposite side of the fabric, but to a substantially lesser degree. It is theorized that the extremely high velocity of the fluid which penetrates the fabric and strikes the backing member can ricochet or rebound after striking the backing member and can repenetrate the fabric in an outward direction, entraining yarn fibers and causing modest fiber raising on the opposite side of the fabric.

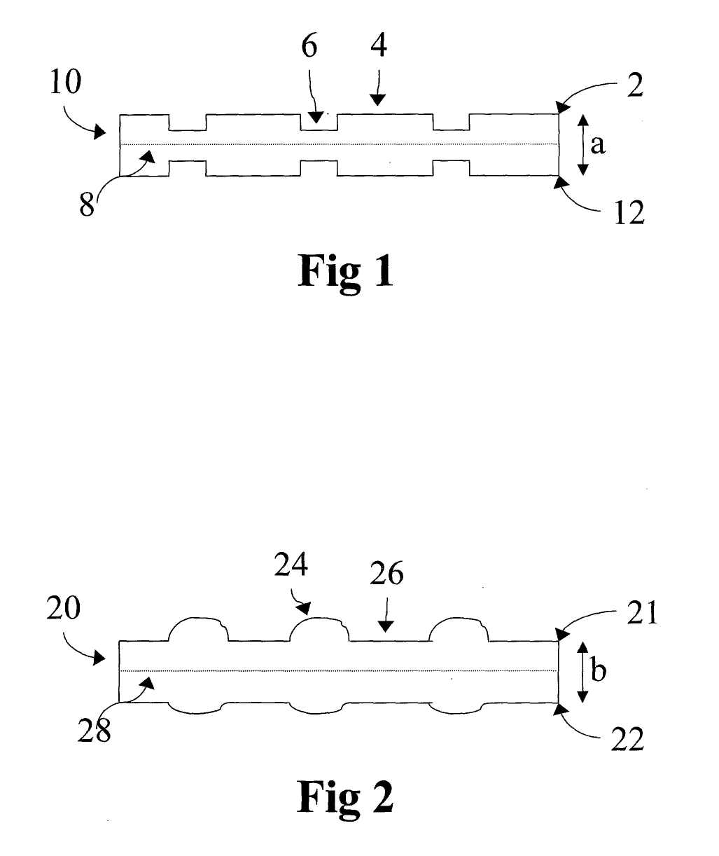

Turning now to the drawings, FIG. 1 is a cross-sectional representation of a nonwoven fabric 10 that has been embossed or thermally bonded. The nonwoven fabric, before embossing or thermally bonding, has an original thickness identified as a. Embossing or thermal bonding, shown on both sides of fabric 10, creates a plurality of discrete regions 6 that project inwardly toward a median plane 8 of nonwoven fabric 10. Typically, embossing patterns are applied to between about 20% to about 30% of the fabric surface. Between patterned regions 6 are regions 4 that are coincident with the fabric surface. For purposes of identification, in FIG. 1, the upper surface of fabric 10 is identified as 2, while the lower surface is identified as 12. In typical embossing or bonding processes, patterned regions 6 project further inwardly on upper surface 2 than they do on lower surface 12. Alternatively, fabric 10 may have inwardly projecting patterned regions 6 on only one side.

FIG. 2 is a cross-sectional representation of a patterned nonwoven fabric 20, according to one embodiment of the present product. The nonwoven fabric, before patterning, has an original thickness identified as b. Patterned nonwoven fabric 20 includes a plurality of discrete regions 24 that project outwardly from a median plane 28 of fabric 20. Between patterned regions 24 are regions 26 that are coincident with the fabric surface. For purposes of identification, in FIG. 2, the upper surface of fabric 20 is identified as 21, while the lower surface is identified as 22. In one embodiment of the patterning process, patterned regions 24 project further outwardly on upper surface 21 than they do on lower surface 22, as has been described above. Alternatively, fabric 20 may have outwardly projecting regions 24 on only one side. In one embodiment, less than 50% of the fabric surface (on a given side) comprises the outwardly projecting pattern.

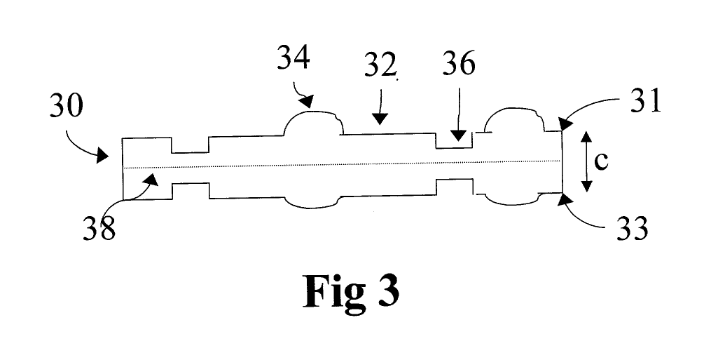

FIG. 3 is a cross-sectional representation of an embossed and patterned nonwoven fabric 30, according to another embodiment of the present product. The nonwoven fabric, before embossing and patterning, has an original thickness identified as c. Patterned nonwoven fabric 30 includes a plurality of discrete regions 34 that project outwardly from a median plane 38 of fabric 30 and a plurality of discrete regions 36 that project inwardly toward median plane 38. Between regions 34, depending on the desired pattern of regions 34, there may be both regions 32 that are coincident with the fabric surface and regions 36 that project inwardly toward median plane 38. For purposes of identification, in FIG. 3, the upper surface of fabric 30 is identified as 31, while the lower surface is identified as 33. In one embodiment of the patterning process, regions 34 project further outwardly on upper surface 31 than they do on lower surface 33. Alternatively, fabric 30 may have outwardly projecting regions 34 on only one side.

As has been described previously, one preferred substrate for use in the present product is a nonwoven fabric comprised of continuous, multi-component filaments. A wide range of synthetic materials may be utilized to create the elementary filaments of the continuous multi-component filaments. The group of polymer materials forming the elementary filaments may be selected from among the following representative groups: polyamides; polyolefins; polyurethanes; aliphatic polyesters; aromatic polyesters; acrylic polymers; any of the above polymers modified by at least one additive; and combinations of any of the above.

In one embodiment, the multi-component filaments present, in cross-section, a configuration of zones representing the cross-sections of the different elementary filaments in the form of wedges or triangular sections. Fibers having a core of one fiber type are typical; for example, in a polyester/polyamide fiber, the core is generally polyamide. Alternatively, fibers having no core portion (that is, hollow core filaments) and fibers without a recognizable “core” are suitable for use in the present product as well. A wide range of distributions of a first fiber type to a second fiber type may be utilized, ranging from 95-5 to 5-95, with 80-20 to 50-50 being distributions that are more common.

Typically, the multi-component filaments have a symmetrical cross-section with a central median axis. It should be noted, however, that the median axis of the multi-component filament can be positioned at a point other than the central line of the filament. The multi-component filament can be unsymmetrical, having elementary filaments with non-uniform cross-sections. The cross-section of the multi-component filaments can be substantially circular in shape or can be comprised of multiple lobes that are joined at a central region. Another variation of the construction of splittable multi-component filaments are those having a cross-section in which ribbons, or fingers, of one component are positioned between ribbons, or fingers, of a second different component. Yet another variation includes either one or a plurality of elementary filaments of one material that are integrated in a surrounding matrix of a second different material. In this case, the matrix is either dissolved or degraded in processing to yield a fabric comprised of single component microdenier fibers. Alternatively, microdenier fibers that are produced by any other means may be used in the present product.

Variations of hydraulic fabric processing techniques known to create patterned surfaces are described in commonly assigned U.S. Pat. No. 5,080,952 to Willbanks and U.S. Pat. No. 5,235,733 to Willbanks et al., the disclosures of which are hereby incorporated by reference.

Specifically, in one embodiment of the hydraulic patterning used to create the present patterned nonwoven, a stencil is interposed between a single jet or an array of jets and the fabric to interrupt the fluid stream. Alternatively, valves may be used to control the fluid streams. When using a stencil, a sleeve-type stencil, comprised of stainless steel, suitable plastic, or other suitable material that serves to mask areas of the fabric that are not to be treated, is placed in fixed relationship over the fabric segment that is attached to a roll. If desired, a traversing means may be used to move the high velocity fluid jet or jets across the face of the stencil as the stencil and fabric are rotated together on the roll. If a sufficiently wide multiple jet array is used, traversing means are unnecessary. The fluid streams directly contact the fabric only where permitted by apertures in the stencil.

In an alternative and preferred stencil embodiment, the stencil is configured to allow the fabric to be patterned to be in the form of a moving web. A cylindrical stencil is arranged to accommodate a multiple jet array orifice assembly within the stencil. In this configuration, the orifice assembly preferably comprises an array of jets that extends across the entire width of the stencil, which in turn extends across the entire width of the fabric web. The orifice assembly is preferably located in close proximity to the inside surface of the cylindrical stencil; the outer surface of the stencil is preferably located in close proximity to, and perhaps in direct contact with, the surface of the fabric. Means are provided to achieve smooth rotation of the stencil in synchronism with the movement of the fabric. This may be achieved, for example, by an appropriate gear train operating on a ring gear that is associated with one or both end of the cylindrical stencil.

It is also contemplated that a single or multiple jet array may be used that is made to traverse within the cylindrical stencil so that the entire width of the fabric may be treated. Use of such traversing jet or jet array would preferably require incremental movement of the fabric, as discussed above.

Certain other approaches for selectively interrupting or otherwise controlling the impact of one or more streams of high velocity fluid on the fabric surface in response to pattern information have also been proposed by others skilled in the art, and may be used to generated the products contemplated herein. Such an apparatus may include computer-activated valves through which the high velocity fluid streams are passed.

Finally, regardless of the patterning technique, patterning may occur either in-line with the fabric formation process or in a separate manufacturing process.

The present patterned nonwoven is useful in a variety of applications, by way of example and not limited to, automotive applications (such as upholstery, headliner, truck liner, and the like), home and office furnishings (such as upholstery, drapery, office panels, shades, and the like), apparel, and industrial applications. Such a fabric represents a useful advancement over the prior art.

We claim:

1. A nonwoven fabric comprising a plurality of continuous filaments, said nonwoven fabric having a first side and a second side, wherein at least a first side of said nonwoven fabric comprises a patternwise arrangement of discrete regions that project outwardly from said patterned side of said nonwoven fabric.

2. The nonwoven fabric of claim 1, wherein said continuous filaments have a filament number in the range of about 0.005 decitex to about 2.0 decitex.

3. The nonwoven fabric of claim 1, wherein said continuous filaments are multi-component filaments having at least a first elementary filament and a second elementary filament that is different from said first elementary filament, said second elementary filament being separable from said first elementary filament.

4. The nonwoven fabric of claim 1, wherein said patternwise arrangement of outwardly projecting regions comprises less than 50% of the surface of said patterned side.

5. The nonwoven fabric of claim 1, wherein the first side of said nonwoven fabric comprises a patternwise arrangement of discrete regions that project outwardly from a median plane of said nonwoven fabric and wherein the second side of said nonwoven fabric comprises a patternwise arrangement of discrete regions that project outwardly from the median plane of said nonwoven fabric.

6. The nonwoven fabric of claim 5, wherein the patternwise arrangement of discrete regions on the first side of said nonwoven fabric projects farther from the median plane of said nonwoven fabric than the patternwise arrangement of discrete regions on the second side of said nonwoven fabric.

7. The nonwoven fabric of claim 5, wherein the patternwise arrangement of discrete regions on the first side of said nonwoven fabric is coincident with the patternwise arrangement of discrete regions on the second side of said nonwoven fabric.

8. A nonwoven fabric having a first surface and a second surface opposite said first surface, wherein at least a first surface of said nonwoven fabric comprises (i) a first patternwise arrangement of discrete regions that project outwardly from a median plane of said nonwoven fabric and (ii) a second patternwise arrangement of discrete regions that project inwardly toward the median plane of said nonwoven fabric.

9. The nonwoven fabric of claim 8, wherein said nonwoven fabric is comprised of continuous filaments.

10. The nonwoven fabric of claim 9, wherein said continuous filaments are multi-component filaments having at least a first elementary filament and a second elementary filament that is different from said first elementary filament, said second elementary filament being separable from said first elementary filament.

11. The nonwoven fabric of claim 10, wherein said first elementary filament and said second elementary filament have a filament number in the range of about 0.005 decitex to about 2.0 decitex.

12. The nonwoven fabric of claim 8, wherein the first side of said nonwoven fabric comprises a first patternwise arrangement of discrete regions that project outwardly from the median plane of said nonwoven fabric and wherein the second side of said nonwoven fabric comprises the first patternwise arrangement of discrete regions that project outwardly from the median plane of said nonwoven fabric.

13. The nonwoven fabric of claim 12, wherein the first patternwise arrangement of discrete regions on the first side of said nonwoven fabric projects farther from the median plane of said nonwoven fabric than the first patternwise arrangement of discrete regions on the second side of said nonwoven fabric.

14. The nonwoven fabric of claim 12, wherein the first patternwise arrangement of discrete regions on the first side of said nonwoven fabric is coincident with the first patternwise arrangement of discrete regions on the second side of said nonwoven fabric.

15. The nonwoven fabric of claim 8, wherein the second patternwise arrangement of discrete regions that projects inwardly toward a median plane of said nonwoven fabric comprises melted fibers.
